(19) United States
(12) Patent Application Publication
(10) Pub. No.: US 2026/0243496 A1
(43) Pub. Date: Aug. 20, 2026

(54) DOOR BODY ASSEMBLY AND REFRIGERATION DEVICE

(71) Applicants: HEFEI MIDEA REFRIGERATOR CO., LTD., Hefei (CN); HEFEI HUALING CO., LTD., Hefei (CN); MIDEA GROUP CO., LTD., Foshan (CN)

(72) Inventors: Jun Li, Hefei (CN); Zhanwei Liu, Hefei (CN); Huawei Zhang, Hefei (CN)

(21) Appl. No.: 19/161,239

(22) PCT Filed: Nov. 18, 2024
(86) PCT No.: PCT/CN2024/132709

§ 371 Date: Aug. 30, 2025

(30) Foreign Application Priority Data
Nov. 27, 2023 (CN) 202323218961.3
Jan. 22, 2024 (CN) 202410088590.1
Aug. 26, 2024 (CN) 202411187622.X

(51) Int. Cl. F25D 23/02; E05D 15/58

(52) U.S. Cl. CPC F25D 23/028; E05D 15/58; F25D 23/021; E05Y 2900/31

(57) ABSTRACT

A door body assembly for a refrigeration device includes a box door rotatably connected to a box body to open or close a storage space, with a first mounting slot formed on an outer side of the box door. A door panel is slidably arranged on the outer side of the box door. A first sliding door mechanism is disposed within the first mounting slot and has one end connected to the box body via a traction mechanism and another end connected to the door panel. The first sliding door mechanism is configured to drive the door panel to move in the width direction of the box door during rotation of the box door. The sliding structure enables relative movement between the door panel and the box door, with the mechanism housed within the door structure.

### CROSS-REFERENCES TO RELATED APPLICATIONS

The present application claims priority to Chinese Patent Application No. 202323218961.3, filed Nov. 27, 2023, entitled “Refrigerator Hinge”, Chinese Patent Application No. 202410088590.1, filed Jan. 22, 2024, entitled “Door Body Assembly and Refrigeration Device”, Chinese Patent Application No. 202411187622. X, filed Aug. 26, 2024, entitled “Door Body Assembly and Refrigeration Device”, which are hereby incorporated by reference in their entireties.

### FIELD

The present application relates to the field of home appliances, and in particular to a door body assembly and a refrigeration device.

### BACKGROUND

With the increasing demand for the integration of home appliances and home furnishings, embedded design of home appliances has become a trend. However, to pursue a better home furnishing integration effect, it is sometimes necessary to fix and connect a door panel on a surface of a box door, and higher requirements are placed on gaps between embedded appliances and cabinet side walls to further improve the home furnishing integration effect. If a traditional hinge technology is used after the appliance is embedded in the cabinet, a door body assembly with door panel and the side wall of a mounting space inside the cabinet will interfere during opening and closing of the door, resulting in the door body assembly of the appliance failing to open or close normally.

### BRIEF SUMMARY

The present application provides a door body assembly and a refrigeration device to solve the problem of interference between a door body assembly with door panel and a side of a mounting space during opening and closing of a door, which may cause the door body assembly of an appliance to fail to open or close normally.

A door body assembly provided by the present application is used for a refrigeration device, where the refrigeration device includes: a box body, and the door body assembly includes:
a box door, rotatably connected to the box body of the refrigeration device, configured to open or close a storage space of the box body, and an outer side of the box door is provided with
a first mounting slot;
a door panel, slidably provided at the outer side of the box door; and
a traction mechanism and a first slide door mechanism, where the first slide door mechanism is provided at the first mounting slot, a first end of the first slide door mechanism is in transmission connection with the box body through the traction mechanism, a second end of the first slide door mechanism is connected to the door panel, during opening or closing of the box door, the traction mechanism drives the first slide door mechanism, to allow the first slide door mechanism to drive the door panel relative to a width direction of the box door.

According to the door body assembly of embodiments of the present application, the first slide door mechanism is vertically provided in the first mounting slot, including:
a first pedestal, formed with a first guide rail at an upper side, and a second guide rail at a lower side;
a first slider, slidably provided at the first guide rail, and is used for transmission connection with the box body through the traction mechanism;
a second slider, slidably provided at the second guide rail, and is used for connection with the door panel; and
a first connector, where two ends of the first connector are connected to the first slider and the second slider;
during opening or closing of the box door, the first slider and the second slider move in opposite directions to drive the door panel to move relative to the width direction of the box door.

According to the door body assembly of embodiments of the present application, the first guide rail and the second guide rail are provided parallel and side by side.

According to the door body assembly of embodiments of the present application, the outer side of the box door is provided with a second mounting slot; and
the door body assembly further includes: a second slide door mechanism and a link, where the second slide door mechanism is provided at the second mounting slot, and a first end of the second slide door mechanism is connected to the first slider through the link, a second end of the second slide door mechanism is connected to the door panel, the second slide door mechanism is configured to match the first slide door mechanism to drive the door panel to move relative to the width direction of the box door during opening or closing of the box door.

According to the door body assembly of embodiments of the present application, the second slide door mechanism is vertically provided in the second mounting slot, including:
a second pedestal, formed with a third guide rail at an upper side, and a fourth guide rail at a lower side;
a third slider, slidably provided at the third guide rail, and connected to the first slider through the link;
a fourth slider, slidably provided at the fourth guide rail, and is used for connection with the door panel; and
a second connector, where two ends of the second connector are connected to the third slider and the fourth slider;
during opening or closing of the box door, the third slider and the fourth slider move in opposite directions to drive the door panel to move relative to the width direction of the box door.

According to the door body assembly of embodiments of the present application, the third guide rail and the fourth guide rail are provided parallel and side by side.

According to the door body assembly of embodiments of the present application, the box door is provided with a third mounting slot, where the third mounting slot is communicated with the first mounting slot and the second mounting slot, and a part of the link is movably provided at the third mounting slot; and
a first end of the link is located at the first mounting slot and connected to the first slider, and a second end of the link is located at the second mounting slot and connected to the third slider.

According to the door body assembly of embodiments of the present application, the outer side of the box door is further provided with a fourth mounting slot, and the door body assembly further includes:
a driven guide rail mechanism, provided at the fourth mounting slot, the driven guide rail mechanism is connected to the door panel, and is configured to match and guide the door panel to move relative to the width direction of the box door during opening or closing of the box door.

According to the door body assembly of embodiments of the present application, one of the first mounting slot and the fourth mounting slot is provided at a top of the outer side of the box door, and another one is provided at a bottom of the outer side of the box door.

A refrigeration device provided by the present application includes:
a box body, formed with a storage space;
the door body assembly mentioned above, where the box door is rotatably connected to the box body, and is configured to open or close the storage space.

The above one or more technical solutions in the embodiments of the present application have at least one of the following technical effects.

According to the door body assembly of embodiments of the present application, by providing the first slide door mechanism at the first mounting slot at the outer side of the box door, the door panel is slidably provided at the outer side of the box door, and the first slide door mechanism is hidden inside the entire door body assembly. Moreover, an end of the first slide door mechanism is in transmission connection with the box body through the traction mechanism, and the second end of the first slide door mechanism is connected to the door panel. During opening or closing of the box door, the first slide door mechanism drives the door panel to move relative to the width direction of the box door, avoiding obstacles such as walls and objects at the side.

According to the refrigeration device of embodiments of the present application, the combination of the door body assembly and the box body allows the door panel of the refrigeration device to avoid interference with surrounding objects in case of opening and closing, improving the convenience of use.

Additional aspects and advantages of the present application will be set forth in part in the description which follows and, in part, will be apparent from the description, or may be learned by practice of the present application.

### BRIEF DESCRIPTION OF THE DRAWINGS

To provide a clearer explanation of the technical solutions in the embodiments of the present application, a brief introduction will be given to the accompanying drawings required for the description of the embodiments. The drawings in the following description are only some embodiments of the present application, and for those skilled in the art, other drawings may be obtained based on these drawings without any creative effort.

FIG. 1 is a schematic disassembly diagram of a refrigeration device according to an embodiment of the present application;

FIG. 2 is a first schematic diagram of a first slide door mechanism and a second slide door mechanism according to an embodiment of the present application;

FIG. 3 is a second schematic diagram of a first slide door mechanism and a second slide door mechanism according to an embodiment of the present application;

FIG. 4 is a schematic diagram of a first slide door mechanism and a second slide door mechanism being provided at a box door according to an embodiment of the present application;

FIG. 5 is a schematic structural sliding diagram of a door body assembly of a refrigeration device according to an embodiment of the present application; and

FIG. 6 is a structural schematic position diagram of a door body assembly of a refrigeration device according to an embodiment of the present application.

### REFERENCE SIGNS

1: first slide door mechanism; 11: first slider; 12: second slider; 13: first pedestal; 131: first guide rail; 132: second guide rail; 14: driven guide rail mechanism;
2: box door; 21: first mounting slot; 22: second mounting slot; 23: third mounting slot; 24: fourth mounting slot;
3: door panel; 4: box body; 5: hinge; 6: first cabinet body; 7: second cabinet body; 8: link; 9: traction mechanism; 10: second slide door mechanism; 101: second pedestal; 1011: third guide rail; 1012, fourth guide rail; 102: third slider; 103: fourth slider.

### DETAILED DESCRIPTION

Implementations of the present application are further described in detail below in conjunction with accompanying drawings and embodiments. The following embodiments are intended to illustrate the present application, but not to limit the scope of the present application.

In the description of the embodiments of the present application, it is to be noted that the orientation or positional relationships indicated by terms such as “center”, “longitudinal”, “lateral”, “upper”, “lower”, “front”, “rear”, “left”, “right”, “vertical”, “horizontal”, “top”, “bottom”, “inside”, “outside”, etc. are based on the orientation or positional relationship shown in the drawings, and are merely for the convenience of describing the embodiments of the present application and simplifying the description, rather than indicating or implying that the device or component stated must have a particular orientation, is constructed and operated in a particular orientation, and thus is not to be construed as limiting the embodiments of the present application. Moreover, the terms “first”, “second”, “third”, and the like are used for descriptive purposes only and are not to be construed as indicating or implying relative importance.

In the description of embodiments of the present application, it should be noted that, unless otherwise explicitly specified and defined, the terms “connected to” and “connected” shall be understood broadly. For example, it may be either fixedly connected or detachably connected, or may be integrally connected; it may be either mechanically connected, or electrically connected; it may be either directly connected, or indirectly connected through an intermediate medium. The specific meanings of the terms above in embodiments of the present application may be understood by those skilled in the art in accordance with specific conditions.

In the embodiments of the present application, unless otherwise clearly stated and defined, the first feature being located “on” or “under” the second feature means that the first feature is in direct contact with the second feature or the first feature is in contact with the second feature by an intervening medium. In addition, the first feature is “on”, “above” and “over” the second feature may refer to that the first feature is directly above or obliquely above the second feature, or simply refer to that the level height of the first feature is higher than that of the second feature. The first feature is “under”, “below” and “beneath” the second feature may refer to that the first feature is directly below or obliquely below the second feature, or simply refer to that the level height of the first feature is lower than that of the second feature.

In the description of this specification, descriptions with reference to the terms “one embodiment”, “some embodiments”, “examples”, “specific examples”, or “some examples” etc. mean that specific features, structure, materials or characteristics described in conjunction with the embodiment or example are included in at least one embodiment or example of the embodiments of the present application. In this specification, the schematic expressions of the above terms do not necessarily refer to the same embodiment or example. Furthermore, the particular features, structures, materials or characteristics described can be combined in any suitable manner in any one or more embodiments or examples. In addition, those skilled in the art may combine the different embodiments or examples described in this specification, as well as the features of the different embodiments or examples, without conflicting each other.

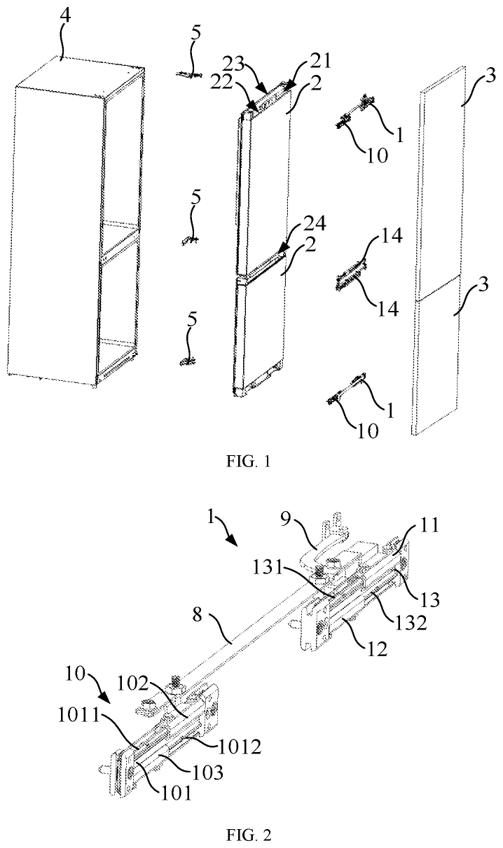

The door body assembly and refrigeration device of the present application will be described below in conjunction with FIG. 1 to FIG. 6. The door body assembly in the present application may be used for household appliances such as refrigerators, but it should be understood that the door body assembly in the present application may also be used for dishwashers, washing machines, or any other suitable devices. The refrigeration device in the present application is applied, for example, as a refrigerator, but it should be understood that the refrigeration device in the present application may also be applied as a freezer or any other suitable devices.

In an embodiment of the present application, as shown in FIG. 1 to FIG. 4, the door body assembly is used for a refrigeration device, and the refrigeration device includes a box body 4. The door body assembly includes: a box door 2, a door panel 3, a traction mechanism 9, and a first slide door mechanism 1. The box door 2 is rotatably connected to the box body 4 of the refrigeration device, configured to open or close a storage space of the box body 4, and an outer side of the box door 2 is provided with a first mounting slot 21; the door panel 3 is rotatably provided at the outer side of the box door 2; and the first traction mechanism 1 is provided at the first mounting slot 21, a first end of the first slide door mechanism 1 is in transmission connection with the box body 4 through the traction mechanism 9, a second end of the first slide door mechanism 1 is connected to the door panel 3, during opening or closing of the box door 2, the traction mechanism 9 drives the first slide door mechanism 1, to allow the first slide door mechanism 1 to drive the door panel 3 relative to a width direction of the box door 2.

In this embodiment, to assemble the first slide door mechanism 1, the first mounting slot 21 is designed at the outer side of the box door 2, and the first mounting slot 21 provides a mounting position and space for the first slide door mechanism 1. To allow the door panel 3 to avoid obstacles such as walls and objects on the side, the door panel 3 is slidably provided at the outer side of the box door 2. The traction mechanism 9 is mainly used to connect the box body 4 and the first slide door mechanism 1, to transmit power, and is responsible for converting the movement of the box body 4 (such as opening or closing) into a driving force of the first slide door mechanism 1.

When a user rotates the box door 2, the traction mechanism 9 drives the first slide door mechanism 1 to perform corresponding actions under the relative motion between the box door 2 and the box body 4. The first slide door mechanism 1 is provided at the first mounting slot 21 at the outer side of the box door 2. The first end of the first slide door mechanism 1 is in transmission connection with the box body 4 through the traction mechanism 9, and the second end is connected to the door panel 3. In this way, when the box door 2 is opened or closed, the first slide door mechanism 1 receives the driving force from the traction mechanism 9 and drive the door panel 3 to move relative to the width direction of the box door 2 to avoid obstacles such as walls and objects on the side.

According to the door body assembly of embodiments of the present application, by providing the first slide door mechanism 1 at the first mounting slot 21 at the outer side of the box door 2, the first slide door mechanism 1 is hidden within the entire door body assembly. An end of the first slide door mechanism 1 is in transmission connection with the box body 4 through the traction mechanism 9, and the second end of the first slide door mechanism 1 is connected to the door panel 3. The first slide door mechanism 1 drives the door panel 3 to move relative to the width direction of the box door 2 during opening or closing of the box door 2, allowing the door panel 3 to avoid obstacles such as walls and objects on the side.

In some embodiments, as shown in FIG. 1 to FIG. 4, the first slide door mechanism 1 is vertically provided in the first mounting slot 21, and the first slide door mechanism 1 includes: a first pedestal 13, a first slider 11, a second slider 12, and a first connector. The first pedestal 13 is formed with a first guide rail 131 at an upper side, and a second guide rail 132 at a lower side; the first slider 11 is slidably provided at the first guide rail 131, and is used for transmission connection with the box body 4 through the traction mechanism 9; the second slider 12 is slidably provided at the second guide rail 132, and is connected to the door panel 3; the first connector, where two ends of the first connector are connected to the first slider 11 and the second slider 12; when the first slider 11 moves at the first guide rail 131, the first slider 11 drives the second slider 12 to move in the opposite direction at the second guide rail 132 through the first connector, to drive the door panel 3 to move relative to the width direction relative to the box door 2.

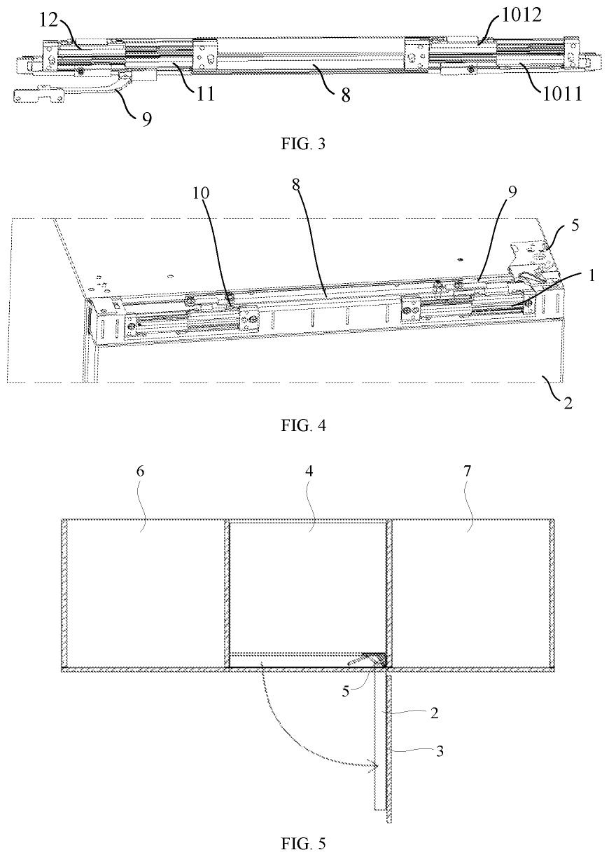

In an embodiment, as shown in FIG. 2 and FIG. 3, the first guide rail 131 is located at the upper side of the first pedestal 13, providing a slide track for the first slider 11. The second guide rail 132 is located at the lower side of the first pedestal 13, parallel or at a certain angle to the first guide rail 131, providing a slide track for the second slider 12. The first slider 11 is slidably provided at the first guide rail 131, and is in transmission connection with the box body 4. The second slider 12 is slidably provided at the second guide rail 132 and connected to the door panel 3. Two ends of the first connector are respectively connected to the first slider 11 and the second slider 12.

When the box door 2 is opened or closed, the relative movement between the box body 4 and the box door 2 causes the first slider 11 to be driven to move at the first guide rail 131. As the two ends of the first connector are fixed to the first slider 11 and the second slider 12 respectively, by providing an extension direction of the first connector reasonably, the first connector will drive the second slider 12 to move in the opposite direction at the second guide rail 132. This synchronous reverse movement feature allows the door panel 3 to slide relative to the width direction of the box body 4.

In the first slide door mechanism 1 provided by the present application, by providing the first slider 11 and the second slider 12 at the first guide rail 131 and the second guide rail 132 respectively, and connecting the first slider 11 and the second slider 12 by the first connector, when the first slider 11 moves, it may drive the second slider 12 to move in the opposite direction. Therefore, when the first slider 11 is in transmission connection with the box body 4, and the second slider 12 is connected to the door panel 3, the first slide door mechanism 1 may be used to drive the door panel 3 to slide in the width direction relative to the box door 2, enabling the door panel 3 to avoid obstacles such as walls and objects on the side during closing or opening of the box door 2, and meeting the needs of the user in different scenarios.

It should be noted that in practical applications, the design of the first slider 11 and the second slider 12 may be flexible and varied to adapt to different operation scenarios and performance requirements. The first slider 11 and the second slider 12 are not limited to specific shapes, sizes, or materials, but may be customized and optimized according to specific needs.

From a material perspective, the first slider 11 and the second slider 12 may be made of materials with high wear resistance, low friction coefficient, and good stability, such as metal alloys, engineering plastics, or special lubricating materials. The selection of these materials aims to improve the durability of the slider, reduce wear and noise during sliding, and ensure smooth sliding.

In terms of structural design, the first slider 11 and the second slider 12 may adopt various forms of guide rail contact surfaces, such as planar contact, ball contact, or sliding bearing contact, etc. These different contact modes each has advantages and disadvantages, for example, ball contact may reduce friction and wear, but the cost is relatively high; flat contact, on the other hand, has a simple structure but may require more frequent lubrication and maintenance. Therefore, when choosing, factors such as usage conditions, cost-effectiveness, and maintenance convenience should be comprehensively considered.

In addition, to enhance the load-bearing capacity and stability of the slider, reinforce ribs, support plates, or other auxiliary structures may be added to the first slider 11 and the second slider 12. These structures may increase the rigidity and deformation resistance of the sliders, ensuring stable slide performance when bearing the weight of the door panel 3 and external forces.

In some embodiments, as shown in FIG. 5, the first connector includes a first flexible cable and a second flexible cable, which may be made of ropes. The first flexible cable passes around a first end of the first pedestal 13 and is connected to the first end of the first slider 11 and the first end of the second slider 12 at two ends; the second flexible cable passes around a second end of the first pedestal 13, and is connected to the second end of the first slider 11 and the second end of the second slider 12 at two ends.

In an embodiment, a first end of the first flexible cable is fixed at a preset position at the first slider 11, then passes around a specific part of the first pedestal 13 (such as a pulley or guide device at the pedestal), and finally connects to a corresponding position of the second slider 12. In this way, when the first slider 11 moves at the first guide rail 131, the first flexible cable may smoothly transmit this motion and drive the second slider 12 to move in the opposite direction at the second guide rail 132.

Similarly, the second flexible cable also passes around the second end of the first pedestal 13, but a path is different from the first flexible cable to ensure balance and stability between the two sliders. A first end of the second flexible cable is fixed at another preset position at the first slider 11 (opposite to a connection point of the first flexible cable), passing around another side of the first pedestal 13, and finally connected to the second end of the second slider 12. This dual flexible cable design not only enhances the reliability of the connection, but also makes the entire first slide door mechanism 1 smoother and more stable during operation.

By adjusting a bypass path and fixed point position of the first flexible cable and the second flexible cable at the first pedestal 13, the performance of the slide door mechanism may be further optimized. For example, a tension of the first flexible cable and the second flexible cable may be adjusted to ensure the synchronization and consistency of the first slider 11 and the second slider 12 during movement.

In this embodiment, as shown in FIG. 1 to FIG. 4, the first mounting slot 21 is located at the outer side of the box door 2, and the first slide door mechanism 1 is vertically provided in the first mounting slot 21. Compared to horizontally providing the first slide door mechanism 1, a depth of the first mounting slot 21 may be reduced to a certain extent, which may reduce a thickness of the box door 2. The first guide rail 131 and the second guide rail 132 are provided parallel and side by side, which not only enhances the stability and load-bearing capacity of the first slide door mechanism 1, but also makes the movement of the first slider 11 and the second slider 12 smoother and more stable. The first guide rail 131 faces upwards, which makes it easier for the first slider 11 at the first guide rail 131 to connect with the traction mechanism 9. The traction mechanism 9 is usually located near a top of the box body 4. The second guide rail 132 faces downwards to be opposite to the first guide rail 131, and is matched with and connected to the door panel 3.

In some embodiments, a first ball and a first support are provided between the first slider 11 and the first guide rail 131, as well as between the second slider 12 and the second guide rail 132. The first support is provided with a first roll notch, and the first ball is rollably provided in the first roll notch.

In this embodiment, by providing the first support between the first slider 11 and the first guide rail 131, and the first support between the second slider 12 and the second guide rail 132, a position of the first ball is limited, and the first ball is prevented from deviating during rolling, making the sliding of the first slider 11 and the second slider 12 more stable and reliable.

In an embodiment, the first roll notch is an arc-shaped notch that matches a shape of the first ball. By providing the arc-shaped notch, the limiting effect of the first ball is enhanced. When the first roll notch contacts the first ball, a force area is larger and a force is more dispersed, which may reduce the wear between the first support and the first ball, and extend the service life.

In some embodiments, as shown in FIG. 1 to FIG. 4, the outer side of the box door 2 is provided with a second mounting slot 22; the door body assembly further includes: a second slide door mechanism 10 and a link 8, where the second slide door mechanism 10 is provided at the second mounting slot 22, and a first end of the second slide door mechanism 10 is connected to the first slider 11 through the link 8, the second end of the second slide door mechanism 10 is connected to the door panel 3, the second slide door mechanism 10 is configured to match the first slide door mechanism 1 to drive the door panel 3 to move relative to the width direction of the box door 2 during opening or closing of the box door 2.

In an embodiment, the second mounting slot 22 is provided at the outer side of the box door 2, and the second mounting slot 22 provides a mounting space for the second slide door mechanism 10. The main function of the second slide door mechanism 10 is to match the first slide door mechanism 1. During opening or closing of the box door 2, the second slide door mechanism 10 is also used to drive the door panel 3 to move relative to the width direction of the box door 2. As a part connecting the second slide door mechanism 10 and the first slider 11, the link 8 plays a role in transmitting force and motion. When the second slide door mechanism 10 is driven by the first slider 11 at the first slide door mechanism 1, the second slide door mechanism 10 may match the driving door panel 3 to move. This design allows the door panel 3 to be driven by the first slide door mechanism 1 and further driven by the second slide door mechanism 10, increasing the driving force when the door panel 3 moves, and enhancing the smoothness of movement of the door panel 3 relative to the box door 2.

In some embodiments, as shown in FIG. 1 to FIG. 4, the second slide door mechanism 10 is vertically provided in the second mounting slot 22, including: a second pedestal 101, a third slider 102, a fourth slider 103, and a second connector. The second pedestal 101 is formed with a third guide rail 1011 at an upper side, and a fourth guide rail 1012 at a lower side;
the third slider 102 is slidably provided at the third guide rail 1011, and connected to the first slider 11 through the link 8;
the fourth slider 103 is slidably provided at the fourth guide rail 1012, and is used for connection with the door panel 3; and
the second connector is connected to the third slider 102 and the fourth slider 104 at two ends respectively; during opening or closing of the box door 2, the third slider and the fourth slider move in opposite directions to drive the door panel 3 to move relative to the width direction of the box door 2.

In this embodiment, the second pedestal 101 serves as a main body of the second slide door mechanism 10, providing a stable mounting foundation and sliding track. The third guide rail 1011 formed by the second pedestal 101 is a slide path of the third slider 102, and the fourth guide rail 1012 formed is a slide path of the fourth slider 103. The third slider 102 is slidably provided at the third guide rail 1011, and matches a transmission of the first slider 11 by the link 8. The fourth slider 103 is slidably provided at the fourth guide rail 1012 and connected to the door panel 3.

During sliding, the third slider 102 is driven by the link 8 and moves linearly along the third guide rail 1011, driving the fourth slider 103 to move, and causing the door panel 3 to move accordingly. The link 8 connects the first slider 11 and the third slider 102, allowing the second slide door mechanism 10 to receive a driving force from the first slide door mechanism 1 and transmit the driving force to the door panel 3, driving the door panel 3 to move.

In this embodiment, as shown in FIG. 2 to FIG. 5, the second mounting slot 22 is located at the outer side of the box door 2, and the second slide door mechanism 10 is vertically provided in the second mounting slot 22. The third guide rail 1011 is coaxially provided with the first guide rail 131, and the third guide rail 1011 and the fourth guide rail 1012 are provided parallel and side by side. When the first slider 11 moves at the first guide rail 131, the link 8 drives the third slider 102 to move synchronously at the third guide rail 1011, and adjusts positions of the first slider 11 and the third slider 102 through the single traction mechanism 9. The door panel 3 may move under the drive of the second slider 12 and the fourth slider 103.

To facilitate mounting of the first slide door mechanism 1, the second slide door mechanism 10, and the link 8, as shown in FIG. 1 to FIG. 3, the box door 2 is provided with a third mounting slot 23, where the third mounting slot 23 is communicated with the first mounting slot 21 and the second mounting slot 22, and a part of the link 8 is movably provided at the third mounting slot 23; and a first end of the link 8 is located at the first mounting slot 21 and connected to the first slider 12, and a second end of the link 8 is located at the second mounting slot 22 and connected to the third slider 103.

In practical applications, due to factors such as machine tool accuracy, tool wear, and material unevenness, there may be certain errors in the machining of the first guide rail 131, the second guide rail 132, the third guide rail 1011, the fourth guide rail 1012, the first pedestal 13, and the second pedestal 101. These errors may include dimensional errors (such as deviations in length, width, and height), shape errors (such as straightness, flatness, and roundness, etc.), and positional errors (such as coaxiality, parallelism, and perpendicularity, etc.). The parallelism between the first guide rail 131 and the second guide rail 132 is evaluated by measuring a relative positional deviation therebetween. This deviation needs to be controlled within a certain tolerance range to ensure smooth sliding of the corresponding slider and stable operation of a system.

That is to say, in this embodiment, the direction of the guide rails being provided as parallel or perpendicular should not be strictly geometrically parallel or perpendicular. At least manufacturing and mounting errors should be considered. Positive and negative 10° errors should be understood within the scope protected by the present application.

In an example, a second ball and a second support are provided between the third slider 102 and the third guide rail 1011, as well as between the fourth slider 103 and the fourth guide rail 1012. The second support is provided with a second roll notch, and the second ball is rollably provided in the second roll notch.

In this embodiment, by providing the second support between the third slider and the third guide rail 1011, and the second support between the fourth slider 103 and the fourth guide rail 1012, a position of the second ball is limited, and the second ball is prevented from deviating during rolling, making the sliding of the third slider more stable and reliable.

In general, the second roll notch is an arc-shaped notch that matches a shape of the second ball. By providing the arc-shaped notch, the limiting effect of the second ball is enhanced. When the second ball roll notch contacts the second ball, a force area is larger and a force is more dispersed, which may reduce the wear between the second ball support and the second ball, and extend the service life.

In this embodiment, the link 8 serves as a key part connecting the first slide door mechanism 1 and the second slide door mechanism 10, and its mounting is crucial. In this embodiment, a part of the link 8 is movably provided at the third mounting slot 23. This design allows the link 8 to flexibly adapt to a relative position change of parts in the first slide door mechanism 1 and the second slide door mechanism 10 during movement, ensuring the stability and reliability of the connection. The first end of link 8 is located in the first mounting slot 21 and is tightly connected to the first slider 11 in the first slide door mechanism 1. In this way, when receiving a driving force, the first slide door mechanism 1 may transmit this force to the second slide door mechanism 10 through the link 8. At the same time, the second end of link 8 is located in the second mounting slot 22 and connected to the third slider 102 of the second slide door mechanism 10. In this way, the second slide door mechanism 10 may receive the driving force from the first slide door mechanism 1, and match and drive the door panel 3 to move accordingly. The communication design of the third mounting slot 23 is used to mount the link 8, which ensures stable and smooth connections between various parts, improving the stability and reliability of the entire door body assembly. Moreover, the providing of the third mounting slot 23 makes a layout of the first slide door mechanism 1, the second slide door mechanism 10, and the link 8 more reasonable and compact, saving space inside the box door 2.

In an embodiment of the present application, as shown in FIG. 1 to FIG. 4, two ends of the traction mechanism 9 are rotatably connected to the box body 4 and the first slider 11 respectively. In an embodiment, the traction mechanism 9 includes a traction rod, a first shaft fix seat, and a second shaft fix seat. The traction rod may be a straight guide rod or a curved guide rod, which may be adjusted according to specific needs. The first shaft fix seat is connected to the first slider 11, and the second shaft fix seat is used to connect to the box body 4. A first end of the traction rod is rotatably connected to the first shaft fix seat, and a second end of the traction rod is rotatably connected to the second shaft fix seat.

In this embodiment, by fixing the first second shaft fix seat and the second shaft fix seat respectively at the first slider 11 and the box body 4, and connecting the first second shaft fix seat and the second shaft fix seat through the traction rod therebetween, when the box door 2 rotates relative to the box body 4, an angle between the box body 4 and the box door 2 changes. The first slider 11 is pulled by a transmission connection of the traction rod, the first shaft fix seat, and the second shaft fix seat, causing the first slider 11 to slide at the first pedestal 13 and driving the second slider 12 to slide, to move the door panel 3 relative to the box door 2.

In some embodiments, as shown in FIG. 4, the outer side of the door panel 3 is also provided with a fourth mounting slot 24, and the door body assembly further includes a driven rail mechanism 14. The driven guide rail mechanism 14 is provided at the fourth mounting slot 24, and the driven guide rail mechanism 14 is connected to the door panel 3. and is configured to match and guide the door panel 3 to move relative to the width direction of the box door 2 during opening or closing of the box door 2.

In an embodiment, the fourth mounting slot 24 provides mounting space for the driven rail mechanism 14. The main function of the driven guide rail mechanism 14 is to guide the door panel 3 to move relative to the width direction of the box door 2 during opening or closing of the box door 2. This design allows the door panel 3 to be driven by the first slide door mechanism 1 and the second slide door mechanism 10, and further guided by the driven guide rail mechanism 14, increasing the smoothness of the movement of the door panel 3 relative to the box door 2.

The driven guide mechanism 14 includes: a third pedestal and a fifth slider. A fifth guide rail is formed at an outer side of the third pedestal; the fifth slider is slidably provided at the fifth guide rail. In this embodiment, the fifth pedestal serves as a main body of the driven rail mechanism 14, while the third pedestal provides a stable mounting foundation and sliding track. The fifth guide rail formed by the fifth pedestal is a path for the fifth slider to slide. The fifth slider is directly connected to door panel 3. During sliding, the fifth slider will move linearly along the fifth guide rail, driving the door panel 3 to move accordingly. Due to the direct connection between the fifth slider and the door panel 3, sliding performance and stability of the fifth slider will directly affect the movement effect of door panel 3.

Based on the above embodiments, in some embodiments, one of the first mounting slot 21 and the fourth mounting slot 24 is provided at a top of the outer side of the box door 2, and another one is provided at a bottom of the outer side of the box door 2.

Generally, the first mounting slot 21, the second mounting slot 22, and the third mounting slot 23 are all provided at the top of the outer side of the box door 2, used to match the providing of the first slide door mechanism 1, the second slide door mechanism 10, and the link 8. The fourth mounting slot 24 is provided at the bottom of the outer side of the box door 2, used to provide the driven guide rail mechanism 14. By providing the first slide door mechanism 1, the second slide door mechanism 10, the link 8, and the driven guide rail mechanism 14, the upper part of the door panel 3 is driven by the first slide door mechanism 1 and the second slide door mechanism 10, and the lower part of the door panel 3 is guided by the driven guide rail mechanism 14. The door panel 3 may operate stably during sliding relative to the width direction of the box door 2.

In another embodiment of the present application, as shown in FIG. 1 to FIG. 6, a refrigeration device is provided, including: a box body 4 and the door body assembly provided in any of the above embodiments. The box body 4 is formed with a storage space, and the box door 2 is rotatably connected to the box body 4,, and is configured to open or close the storage space. The door body assembly is used for the refrigeration device, including: a box door 2, a door panel 3, a traction mechanism 9, and a first slide door mechanism 1. The box door 2 is rotatably connected to the box body 4, configured to open or close a storage space of the box body 4, and an outer side of the box door 2 is provided with a first mounting slot 21; the door panel is rotatably provided at the outer side of the box door 2; and the first traction mechanism 1 is provided at the first mounting slot 21, a first end of the first slide door mechanism 1 is in transmission connection with the box body 4 through the traction mechanism 9, a second end of the first slide door mechanism 1 is connected to the door panel 3, during opening or closing of the box door 2, the traction mechanism 9 drives the first slide door mechanism 1, to allow the first slide door mechanism 1 to move the door panel 3 relative to a width direction of the box door 2.

In an embodiment, during rotating and opening of the box door 2 towards the outer side of the box body 4, the first slide door mechanism 1 drives the door panel 3 to slide away from a hinge 5, avoiding interference between the door panel 3 and external obstacles. During rotating and closing of the box door 2 towards the box body 4, the first slide door mechanism 1 drives the door panel 3 to slide towards the hinge 5, avoiding interference between the door panel 3 and obstacles after closing.

In this embodiment, the door panel 3 is provided at the box door 2, and the refrigeration device is embedded. When provided at a slot-type space or between two cabinet bodies, the door panel 3 may be provided at a side wall of the slot or flush with the cabinet bodies at two sides, to reduce the gap between the refrigeration device and the adjacent wall or cabinet bodies, making it more aesthetically pleasing.

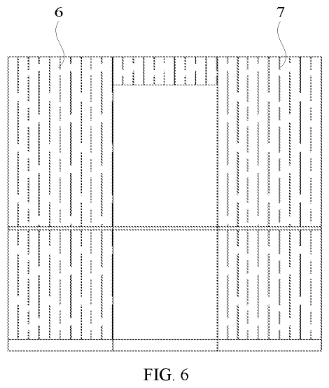

In some embodiments, as shown in FIG. 5 and FIG. 6, the door body assembly and the box body 4 are used to be provided at a mounting space formed between a first cabinet body 6 and a second cabinet body 7, with an opening provided at an outer side of the mounting space. This design allows the door body assembly and the box body 4 to be embedded integrally into the cabinet bodies. During controlling of the opening or closing of the storage space through the opening by the box door 2, the first slide door mechanism 1 is configured to drive the door panel 3 to move a preset distance away from or towards the hinge 5 at the box door 2. The door panel 3 avoids side walls of the first cabinet body 6 and the second cabinet body 7.

During controlling of the opening or closing of the storage space through the opening by the box door 2, the first slide door mechanism 1 is configured to drive the door panel 3 to move a preset distance away from or towards the hinge 5 at the box door 2. Interference between the door panel 3 and the side walls of the first cabinet body 6 and the second cabinet body 7 is avoided, and smooth opening or closing of the door panel 3 through a preset distance of movement without colliding or jamming with the side walls of the cabinet bodies is ensured.

For example, as shown in FIG. 5 and FIG. 6, during opening of the box door 2, the first slide door mechanism 1 drives the door panel 3 to move the preset distance away from the hinge 5 along the box door 2. In this way, the door panel 3 may smoothly avoid the side wall of the second cabinet body 7, allowing the box door 2 to be fully opened, making it convenient for the user to access items.

Similarly, during closing of the box door 2, the first slide door mechanism 1 drives the door panel 3 to move the preset distance towards the hinge 5 along the box door 2. In this way, the door panel 3 may smoothly avoid the side wall of the first cabinet body 6, allowing the box door 2 to be fully closed, maintaining overall aesthetics and sealing.

Finally, it should be noted that the above embodiments are only used to illustrate the present application and not to limit it. Although the present application has been described in detail with reference to the embodiments, those skilled in the art should understand that various combinations, modifications, or equivalent substitutions of the technical solution of the present application do not depart from the scope of the technical solution of the present application, and should be included in the scope of the claims of the present application.

1. A door body assembly for refrigeration device, wherein the refrigeration device comprises a box body, and the door body assembly comprises:
a box door, rotatably connected to the box body of the refrigeration device, configured to open or close a storage space of the box body, and an outer side of the box door is provided with a first mounting slot;
a door panel slidably provided at the outer side of the box door; and
a traction mechanism-and a first slide door mechanism, wherein the first slide door mechanism is provided at the first mounting slot, a first end of the first slide door mechanism is in transmission connection with the box body through the traction mechanism a second end of the first slide door mechanism is connected to the door panel, during opening or closing of the box door, the traction mechanism-drives the first slide door mechanism, to allow the first slide door mechanism-to drive the door panel to move relative to a width direction of the box door.

2. The door body assembly of claim 1, wherein the first slide door mechanism is vertically provided in the first mounting slot, the first slide door mechanism comprising:
a first pedestal formed with a first guide rail at an upper side, and a second guide rail at a lower side;
a first slider, slidably provided at the first guide rail, and is used for transmission connection with the box body through the traction mechanism;
a second slider, slidably provided at the second guide rail, and is used for connection with the door panel; and
a first connector, wherein two ends of the first connector are connected to the first slider and the second slider;
during opening or closing of the box door, the first slider and the second slider move in opposite directions to drive the door panel-to move relative to the width direction of the box door.

3. The door body assembly of claim 2, wherein the first guide rail and the second guide rail are provided parallel and side by side.

4. The door body assembly of claim 2, wherein the outer side of the box door is provided with a second mounting slot; and
the door body assembly further comprises: a second slide door mechanism and a link, wherein the second slide door mechanism is provided at the second mounting slot, a first end of the second slide door mechanism is connected to the first slider through the link, a second end of the second slide door mechanism is connected to the door panel, the second slide door mechanism is configured to match the first slide door mechanism to drive the door panel to move relative to the width direction of the box door during opening or closing of the box door.

5. The door body assembly of claim 4, wherein the second slide door mechanism is vertically provided in the second mounting slot, the second slide door mechanism comprising:
a second pedestal, formed with a third guide rail at an upper side, and a fourth guide rail at a lower side;
a third slider, slidably provided at the third guide rail, and connected to the first slider through the link;
a fourth slider, slidably provided at the fourth guide rail, and is used for connection with the door panel; and
a second connector, wherein two ends of the second connector are connected to the third slider and the fourth slider;
during opening or closing of the box door, the third slider and the fourth slider move in opposite directions to drive the door panel to move relative to the width direction of the box door.

6. The door body assembly of claim 5, wherein the third guide rail and the fourth guide rail are provided parallel and side by side.

7. The door body assembly of claim 5, wherein the box door is provided with a third mounting slot, and wherein the third mounting slot is communicated with the first mounting slot and the second mounting slot, and a part of the link is movably provided at the third mounting slot; and
a first end of the link is located at the first mounting slot and connected to the first slider, and a second end of the link is located at the second mounting slot and connected to the third slider.

8. The door body assembly of claim 1, wherein the outer side of the box door is further provided with a fourth mounting slot, and the door body assembly further comprises:
a driven guide rail mechanism, provided at the fourth mounting slot, the driven guide rail mechanism is connected to the door panel, and is configured to match and guide the door panel to move relative to the width direction of the box door during opening or closing of the box door.

9. The door body assembly of claim 8, wherein one of the first mounting slot and the fourth mounting slot is provided at a top of the outer side of the box door, and another one is provided at a bottom of the outer side of the box door.

10. A refrigeration device, comprising:
a box body, formed with a storage space; and
the door body assembly of claim 1, wherein the box door is rotatably connected to the box body, and is configured to open or close the storage space.
